(19) United States
(12) Patent Application Publication
(10) Pub. No.: US 2025/0342367 A1
(43) Pub. Date: Nov. 6, 2025

(54) DYNAMICALLY GENERATING PROMPTS AND KNOWLEDGE BASES BASED ON USER AND PAGE CONTEXT

(71) Applicant: Dell Products L.P., Round Rock, TX (US)

(72) Inventors: Thirumaleshwara Shama, Austin, TX (US); Shibi Panikkar, Bangalore (IN)

(21) Appl. No.: 18/655,517

(22) Filed: May 6, 2024

(51) Int. Cl. G06N 5/022; G06N 5/04

(52) U.S. Cl. CPC G06N 5/022; G06N 5/04

(57) ABSTRACT

Architectures and techniques are described that can receive an indication that additional information about a dynamic element of a webpage is solicited or requested. In response to the indication, context data can be determined, comprising user context data and page context data. As a function of the context data, prompt data can be generated. The prompt data can be indicative of a natural language query. The prompt data, which was automatically generated, can be input to a model such as a large language model in order to obtain the additional information about the dynamic element.

### BACKGROUND

A web application is a software application that is accessed and interacted with via a web browser over the internet. Unlike traditional desktop applications, which are installed and run locally on a user's computer, web applications are hosted on remote servers and accessed through a web browser interface. Web applications utilize web technologies such as hypertext markup language (HTML), cascading style sheet (CSS), and JavaScript to deliver a user interface and functionality to users. Web applications are typically built using client-server architecture, where the client-side code runs in the user's web browser and communicates with the server-side code running on a remote server. Web applications rely on the use of web pages to communicate with users.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a graphical depiction of a webpage illustrating an example analysis element that can be utilized to present additional information about any suitable element of the webpage in accordance with certain embodiments of this disclosure;

FIG. 2 depicts a schematic block diagram illustrating an example device that can dynamically generate prompts and knowledge bases or knowledge graphs based on context data, which can be utilized to generate additional information in accordance with certain embodiments of this disclosure;

FIG. 3A depicts a schematic block diagram illustrating retrieval of content for a dynamic element in accordance with certain embodiments of this disclosure;

FIG. 3B depicts a schematic block diagram is depicted illustrating an example hierarchical representation of the DOMS that maintains various elements and the DOMS hierarchy in accordance with certain embodiments of this disclosure

FIG. 3C depicts a schematic block diagram illustrating an example knowledge base or knowledge graph that can be generated based on context data in accordance with certain embodiments of this disclosure;

FIG. 4 depicts a schematic block diagram illustrating additional elements or aspect of the example device that can dynamically generate prompts and knowledge bases or knowledge graphs based on context data, which can be utilized to generate additional information in accordance with certain embodiments of this disclosure;

FIG. 5 depicts a schematic process flow diagram illustrating example procedures or functions of the example device or another device or system operatively coupled to the example device in accordance with certain embodiments of this disclosure;

FIG. 6 depicts a schematic block diagram illustrating a more detailed hierarchical view of the knowledge graph in accordance with certain embodiments of this disclosure;

FIG. 7 shows a graphical depiction of a webpage illustrating a first example of the additional information being presented in accordance with certain embodiments of this disclosure;

FIG. 8 shows a graphical depiction of a webpage illustrating a second example of the additional information being presented in accordance with certain embodiments of this disclosure;

FIG. 9 illustrates an example method that can dynamically generate prompts and knowledge bases or knowledge graphs based on context data, which can be utilized to generate additional information in accordance with certain embodiments of this disclosure;

FIG. 10 illustrates an example method that can provide for additional elements or functionality relating to dynamically generating prompts and knowledge bases or knowledge graphs based on context data in accordance with certain embodiments of this disclosure;

FIG. 11 illustrates a block diagram of an example distributed file storage system that employs tiered cloud storage in accordance with certain embodiments of this disclosure; and

FIG. 12 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

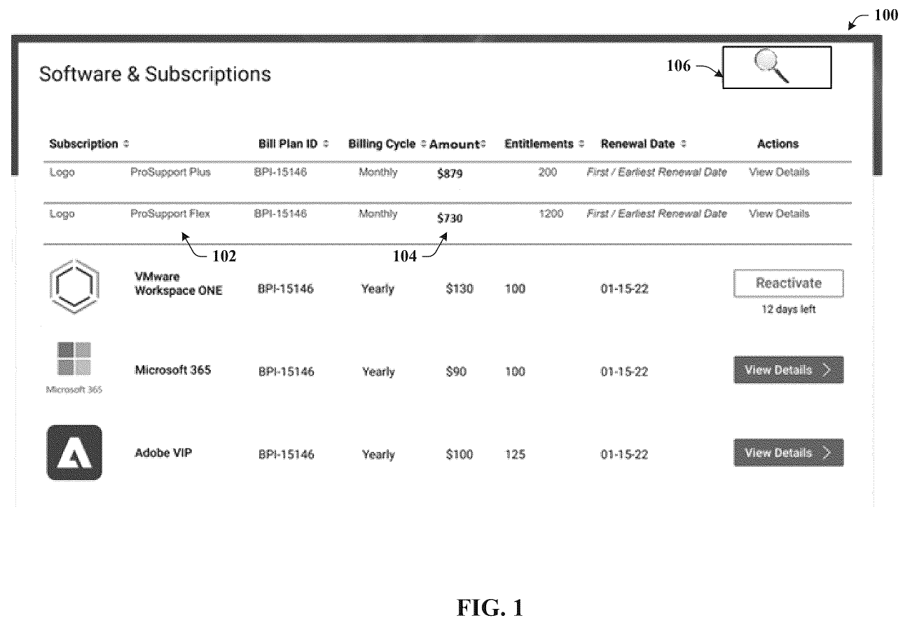

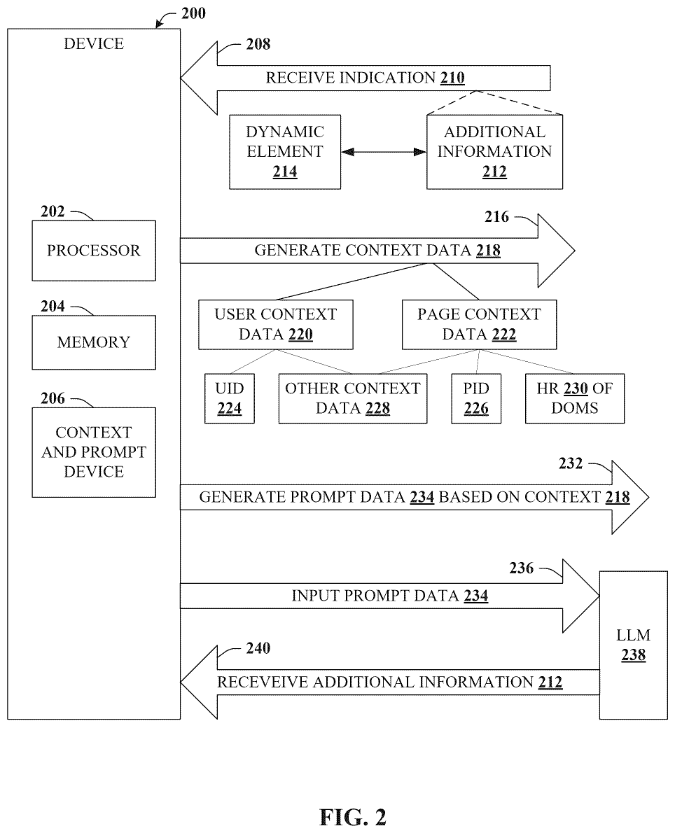

To provide additional context, consider FIG. 1. FIG. 1 shows a graphical depiction of a webpage 100 illustrating an analysis element that can be utilized to present additional information about an element of the webpage 100 in accordance with certain embodiments of this disclosure. Webpage 100 can be generated and/or presented by a web application via a web server or according to any other suitable mechanisms. In the present example, which is considered as a representative example that is used for the remainder of this document, webpage 100 is directed to a software and subscriptions billing webpage. However, it is understood that the techniques described herein can be applicable to other types of webpages. The disclosed techniques can be applicable to any presentation of a webpage that comprises elements described in a document object model (DOM) and/or a DOM structure (DOMS) included in hypertext markup language (HTML) code about which additional information can be solicited and/or requested, which is further detailed in connection with FIG. 2, infra.

In the realm of web applications and/or any suitable presentation of a webpage, it can be instructive for software developers to acknowledge certain inherent limitations in presenting content. Generally, presenting content is subject to numerous constraints such as limited available screen real estate, a finite number of HTML user controls, and potentially other constraints relating to company policies or themes directed to streamlined and user-friendly experiences. As such, many webpages are subject to careful curation of information and presentation. As one result, web applications may not encompass sufficient granular detail within a given interface to satisfy a user entity (e.g., a customer, subscriber, user, and so on) that navigated to the webpage. Having insufficient information for the user entity can lead to reduced satisfaction or experiences for the user entity.

As noted, webpage 100 represents a software and subscriptions billing page. Webpage 100 comprises numerous elements, some of which are static elements 102 such as logos or identifiers. Certain other elements are dynamic elements 104 such as billing amount or the like. Static elements 102 typically do not change based on context, while dynamic elements 104 can vary based on context (e.g., user entity identity, time within a billing cycle, time of last payment, . . . ). Hence, in this example, the actual value presented for a given billing amount (or other dynamic element 104) can be determined by a call to a data store (e.g., an accounts data store, billing data store, . . . ) and populated when the page is requested.

However, as demonstrated by webpage 100, a given web application that presents webpage 100 can evoke a need to portray more granular information than can be accommodated by webpage 100 such as more granular information about subscription details (e.g., more granular information about static element 102), billing amounts due (e.g., more granular information about dynamic element 104), or the like. For instance, consider the scenario in which in certain months, customers might have consumed more of a given resource (e.g., data, support, . . . ) than provided for in a contract, a service level agreement, or the like. In that case, the billing amount may differ significantly from expectation.

Presentation of a single value for billing amount can leave the user entity with confusion or frustration, particularly when the value is more than expected. From the design side, it is not feasible to include granular explanations of all possible situations that lead to the presented value. Furthermore, it is also possible that the presented value can be due to an error, which, if dynamically corrected could be extremely valuable to the user entity. Regardless, of any specific example, it is readily appreciated that a given webpage 100 can significantly benefit from the ability to present more granular information or any other suitable type of information than can be feasibly presented within the existing constraints of webpage 100.

In that regard, the disclosed subject matter is in some embodiments, directed to an analysis element 106 that can be activated or invoked in order to provide additional information about any element presented by webpage 100, including static elements 102 and dynamic elements 104.

For example, a user entity may click on analysis element 106, then subsequently click on the element about which additional information is selected (e.g., a billing amount) in order to trigger the disclosed techniques that are further detailed below. In another embodiment, the user entity may drag-and-drop analysis element 106 onto the suitable element. It is understood that the above embodiments are merely exemplary, as analysis element 106 can be invoked according to any suitable technique, which can include any type of input or selection such as double-click, right-clicks, gestures, voice input, and so on.

Depiction of analysis element 106 is merely one example. In some embodiments, analysis element 106 need not be presented on webpage 100, but rather can be invoked based on any suitable selection or input. Once invoked, analysis element 106 can act as an intelligent extension to the content presented in webpage 100. In that regard, activation of analysis element 106 can utilize user context information, data in any suitable data store, various static analysis techniques, and/or artificial intelligence (AI) or machine learning (ML) generation of additional content requested or solicited by the user entity.

As one example implementation, operation of analysis element 106 can be implemented as a floating module in a given web application that presents webpage 100. Upon triggering, the techniques detailed herein can leverage AI algorithms, intelligent data management techniques, and a large language model (LLM) to generate and present additional information to the customer or other user entity, as further detailed below.

### Example Systems

With reference now to FIG. 2, a schematic block diagram is depicted illustrating an example device 200 that can dynamically generate prompts and knowledge bases or knowledge graphs based on context data, which can be utilized to generate additional information in accordance with certain embodiments of this disclosure. In some embodiments, device 200 can be communicatively coupled to or integrated with a web application.

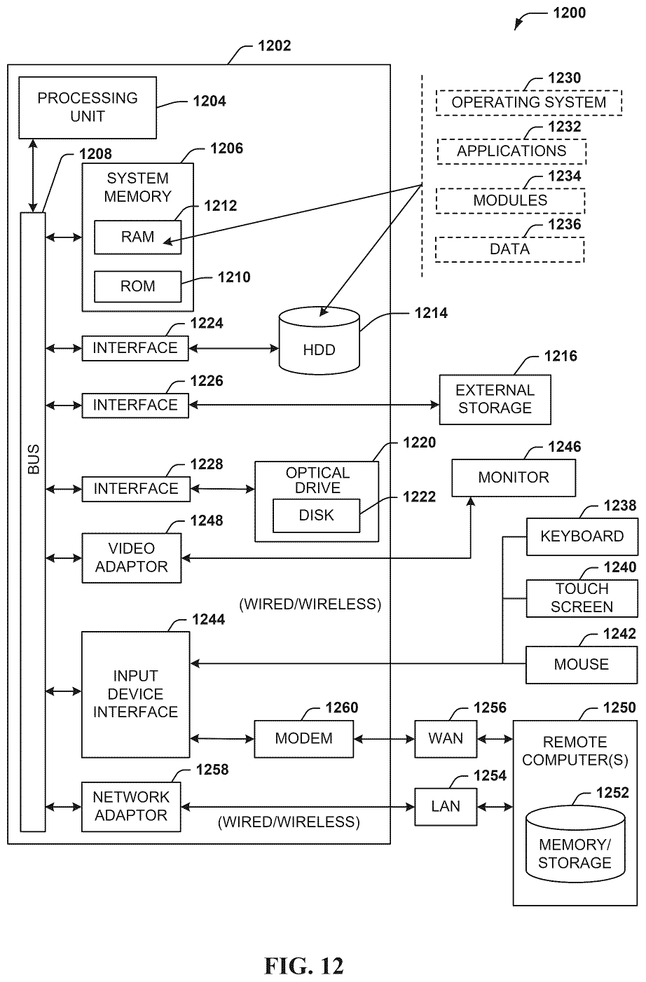

Device 200 can comprise a processor 202 that, potentially along with context and prompt device 206, can be specifically configured to perform functions associated with determining and/or generating certain context data and prompt data, the latter of which can be used as input to a generative AI device and/or an LLM. Device 200 can also comprise memory 204 that stores executable instructions that, when executed by processor 202, can facilitate performance of operations. Processor 202 can be a hardware processor having structural elements known to exist in connection with processing units or circuits, with various operations of processor 202 being represented by functional elements shown in the drawings herein that can require special-purpose instructions, for example, stored in memory 204 and/or context and prompt device 206. Along with these special-purpose instructions, processor 202 and/or context and prompt device 206 can be a special-purpose device. Further examples of the memory 204 and processor 202 can be found with reference to FIG. 12. It is to be appreciated that device 200 or computer 1202 can represent a server device or a client device of a network or data services platform and computer 1202 can be used in connection with implementing one or more of the systems, devices, or components shown and described in connection with FIG. 2 and other figures disclosed herein.

As illustrated at reference numeral 208, device 200 can receive indication 210. Indication 210 can be any suitable indicate that additional information 212 is or has been solicited about dynamic element 214. Hence, indication 210 can be the result of some selection input to a webpage (e.g., webpage 100) that selects the analysis element 106 and subsequently selects the element about which additional information 212 is solicited. As noted, in some embodiments, the selection input might only identify the element about which additional information 212 is solicited, with analysis element 106 being triggered via another means such as a gesture, voice input, or the like. Essentially, indication 210 can be any suitable input or mechanism by which it is determined that additional information 212 is sought (e.g., thereby triggering analysis element 106) and any suitable input or mechanism to identify the target (e.g., dynamic element 214) for additional information 212.

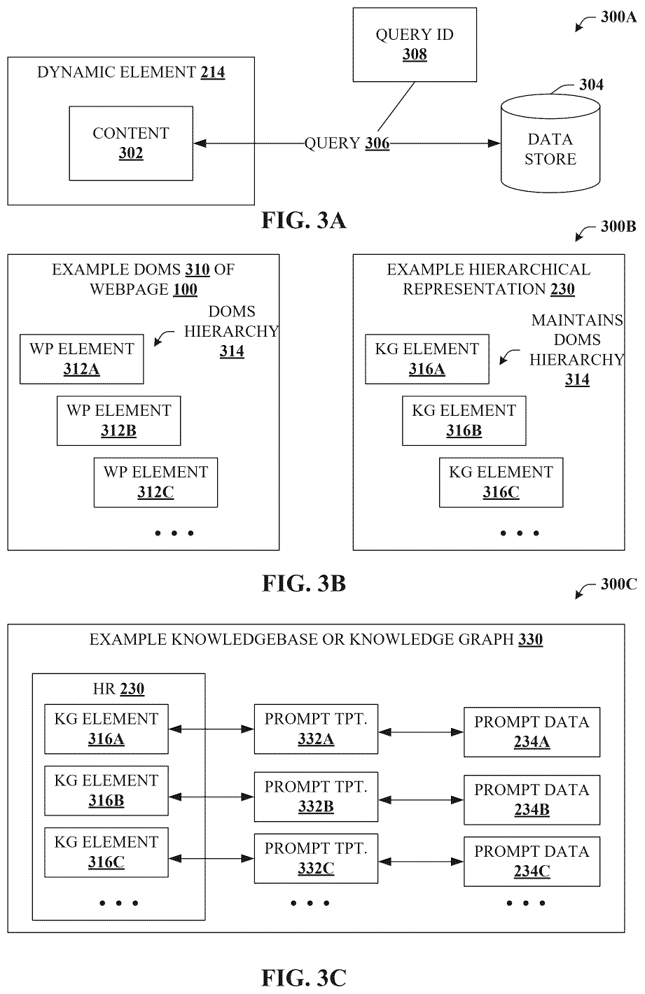

Dynamic element 214 can be substantially similar to dynamic element 104, and additional detail relating to dynamic element 214 is presented at FIG. 3A, which can now be referenced along with FIG. 2. FIG. 3A depicts a schematic block diagram 300A illustrating retrieval of content for a dynamic element 214 in accordance with certain embodiments of this disclosure.

For example, dynamic element 214 can comprise content 302 that is configured to vary (e.g., variable content) according to a determination that occurs when the associated webpage is presented, such as the billing amount detailed previously. In that case, the billing amount (e.g., content 302) can be obtained in response to a query 306 to data store 304. Hence, the billing amount for a given element (e.g., dynamic element 214), and for the particular user entity accessing the webpage, and at the current point in time in the billing cycle can be retrieved from data store 304 via query 306.

In some embodiments, query 306 can be assigned a query ID 308 that can be leveraged as explained below. Once the billing amount is retrieved from data store 304, such can be populated as content 302 of dynamic element 214 and presented on the webpage. It is to be understood that the disclosed techniques can be employed in connection with static elements (e.g., static element 102) as well as that described for dynamic element 214. However, the disclosed techniques substantially focus on a solution that can be used for dynamic elements 214.

Still referring to FIG. 2, in response to receiving indication 210 or otherwise determining that additional information 212 is being solicited, as indicated at reference numeral 216, device 200 can determine and/or generate context data 218. Context data 218 can comprise user context data 220 and page context data 222, as detailed below.

User context data 220 can comprise user identifier 224 that sufficiently identifies (e.g., uniquely) the user entity that accessed the webpage. User context data 220 can further comprise any other suitable information about the user entity such as, e.g., an associated company, department, region, and so on. Such can be represented as other context data 228.

Page context data 222 can comprise a page identifier 226 that identifies (e.g., uniquely) the webpage that is being accessed. Page context data 222 can further comprise hierarchical representation 230 and any other suitable other context data 228. Hierarchical representation 230 can be a representation of a domain object model structure of the underlying webpage, which can maintain the hierarchy that exists in the DOMS, which is further detailed in connection with FIG. 3B.

While still referring to FIG. 2, but turning now as well to FIG. 3B, a schematic block diagram is depicted illustrating an example hierarchical representation 230 of the DOMS 310 that maintains various elements and the DOMS hierarchy 314 in accordance with certain embodiments of this disclosure.

In HTML, a DOM structure (e.g., DOMS 310) can represent the hierarchical structure of elements within an HTML document. The DOM structure can be a tree-like representation of the document's elements (e.g., webpage (WP) elements 312A, 312B, 312C, . . . ) where each element, attribute, and text node can be represented as a node in the tree. The tree can have an associated hierarchy indicated here as DOMS hierarchy 314.

The tree of a given DOMS 310 can include a document node, element nodes, attribute nodes, text nodes, comment nodes, and so on. At the top of the DOM tree is the document node, which represents the entire HTML document. The document node can serve as the root of the DOM tree. Element nodes can represent the HTML elements (e.g., tags) within the document, such as <html>, <head>, <body>, <div>, <p>, <span>, and so on. Each element node may have child elements, attributes, and text content. Attribute nodes can represent the attributes of HTML elements. For example, the src, href, id, class, and style attributes can be represented as attribute nodes associated with their respective elements. Text nodes can represent the textual content within an HTML element. For example, text nodes may contain the actual text content of paragraphs, headings, links, and other elements. Comment nodes can represent HTML comments within the document. Comments are not displayed in the browser but can be included in the DOM structure for reference or documentation purposes. In some embodiments, WP elements 312 can be indicative of the element nodes.

The DOM structure can be dynamically generated by the web browser when parsing an HTML document. Once created, the DOM structure can allow developers to manipulate the content, structure, and styling of the HTML document using JavaScript or other web technologies. Such can enable dynamic and interactive web applications where elements can be added, removed, modified, or rearranged in response to user actions or events.

In some embodiments, and as will be further detailed below, hierarchical representation 230 can be constructed within the context of a knowledge base and/or knowledge graph. All or a portion of WP elements 312 can be represented in hierarchical representation 230 as associated knowledge graph (KG) elements 316 (e.g., KG elements 316A, 316B, 316C, . . . ) having a same or similar tree structure and/or maintaining a same DOMS hierarchy 314.

Still referring to FIG. 2, at reference numeral 232, device 200 can be configured to generate prompt data 234. Prompt data 234 can be generated as a function of context data 218. In other words, prompt data 234 can be generated as a function of one or both user context data 220 or page context data 222. Prompt data 234 can be a dynamically generated prompt or query that is configured to be input to a generative AI application or service such as large language model 238. Hence, rather than a user creating the input to LLM 238, advantageously, such input (e.g., prompt data 234) can be created based on context data 218.

In more detail, a large language model (e.g., LLM 238) is a type of artificial intelligence (AI) model designed to understand and generate human-like text or other input based on the patterns and structures learned from large amounts of textual data. Large language models are typically created using deep learning techniques, specifically recurrent neural networks (RNNs), transformers, or similar architectures.

A large language model is generally characterized by a very large number of parameters contained by the model. Typically, larger models have more parameters, allowing them to capture more intricate patterns and nuances in language. These parameters can be learned during the training process, where the model is exposed to great amounts of text data, such as books, articles, websites, and other sources of written language.

Large language models are capable of performing a variety of natural language processing (NLP) tasks, including: text generation, text summarization, language translation, question answering, language understanding, and so on. In terms of text generation, LLMs can generate coherent and contextually relevant text based on a given prompt (e.g., prompt data 234) and/or input. LLMs can produce human-like responses, complete sentences, paragraphs, or even entire articles.

In terms of text summarization, LLMs can summarize long passages of text by distilling the main ideas and key points into shorter, more concise summaries. In terms of language translation, LLMs can translate text from one language to another, preserving the meaning and intent of the original text, rather than strictly always equating a word in one language to the same word in the second language. In terms of question answering, LLMs can answer questions posed in natural language by extracting relevant information from a given context or knowledge base. In terms of language understanding, LLMs can understand and interpret the meaning of text, including sentiment analysis, named entity recognition, and semantic similarity tasks.

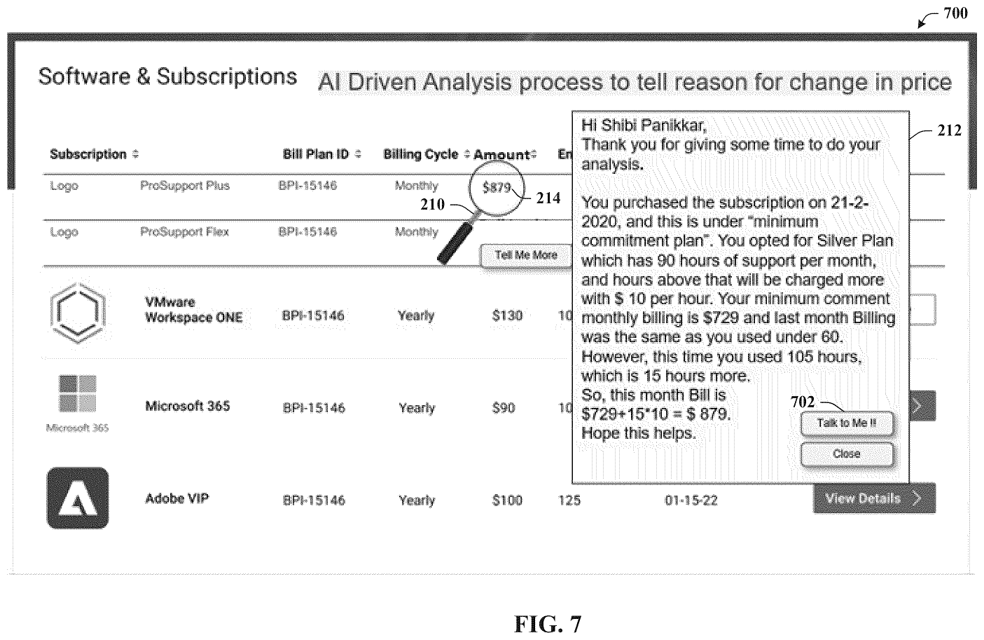

Large language models have a wide range of applications across industries, including content generation, virtual assistants, chatbots, customer support, language translation, and more. In that regard, the disclosed techniques leverage LLM 238 in distinct way from previous uses. For example, prompt data 234, which was dynamically created by device 200, can be input to LLM 238, as illustrated at reference numeral 236. In response, at reference numeral 240, device 200 can receive additional information 212 that was solicited upon receipt of indication 210. In some embodiments, additional information 212 can be presented along with a presentation of webpage 100, an example of which can be found with reference to FIG. 7.

To provide a further illustration, consider an example of prompt data 234 that can be generated by device 200 based on context data 218:
You are a data analyzer and asked to analyze a billing amount found on a webpage. The current billing amount is {reference to dynamic element 214}.
Analyze the current and previous months' billing. In the case of a discrepancy reply “action: Discrepancy”, else give all details of the billing amount.

As can be seen, prompt data 234 can be in the form of natural language, as LLM 238 is designed to understand such. In this example, prompt data 234 initially instructs LLM 238 to operate as a data analyzer in order to (i) analyze the current billing amount (e.g., dynamic element 214, which was selected by the user entity to solicit additional information 212) and report, and (ii) determine if the billing amount is correct and if not report a discrepancy. The prompt data 234 can be adjusted according to the type of dynamic element 214 (e.g., billing in this example, but such can be adjusted for any type of element or category of webpage). It is again underscored that prompt data 234 (e.g., input to LLM 238) is dynamically generated rather than being constructed by the user entity. Further, prompt data 234 can be generated as a function of context data 218, which if further detailed below in connection with FIG. 3C and other FIGS. herein.

With reference now to FIG. 3C, a schematic block diagram 300C is depicted illustrating an example knowledge base or knowledge graph 330 that can be generated based on context data 218 in accordance with certain embodiments of this disclosure. For example, a different knowledge graph 330 can be generated for each different webpage 100 presented by the web application and for each different user entity. In other words, each knowledge graph 330 can be tied to a specific user identifier 224 and a specific page identifier 226. As one result, when additional information 212 is solicited, the associated knowledge graph 330 can be specific to that particular request and can therefore be relatively small in size and results quickly identified.

As illustrated, knowledge graph 330 can comprise hierarchical representation 230, which can comprise KG elements 316. For each respective KG element 316, knowledge graph 330 can contain a respective prompt template 332 such as prompt template 332A, 332B, 332C, and so on. Recall that hierarchical representation 230 can comprise a different KG element 316 and a same DOMS hierarchy 314 for each WP element 312 in the DOMS 310. Thus, each prompt template 332 can be specific to a particular KG element 316 and, by proxy, specific to a particular WP element 312. Thus, device 200 can apply context data 218 to a given prompt template 332 in order to generate prompt data 234, namely prompt data 234A, 234B, 234C, and so on.

Hence, a given instance of prompt data 234 can be generated for each respective WP element 312 (and/or KG element 316) and can be tailored for that particular element via an associated prompt template 332. Further, as noted, different instances of knowledge graph 330 can exist for respective webpages 100 and different user entities that access the respective webpages 100.

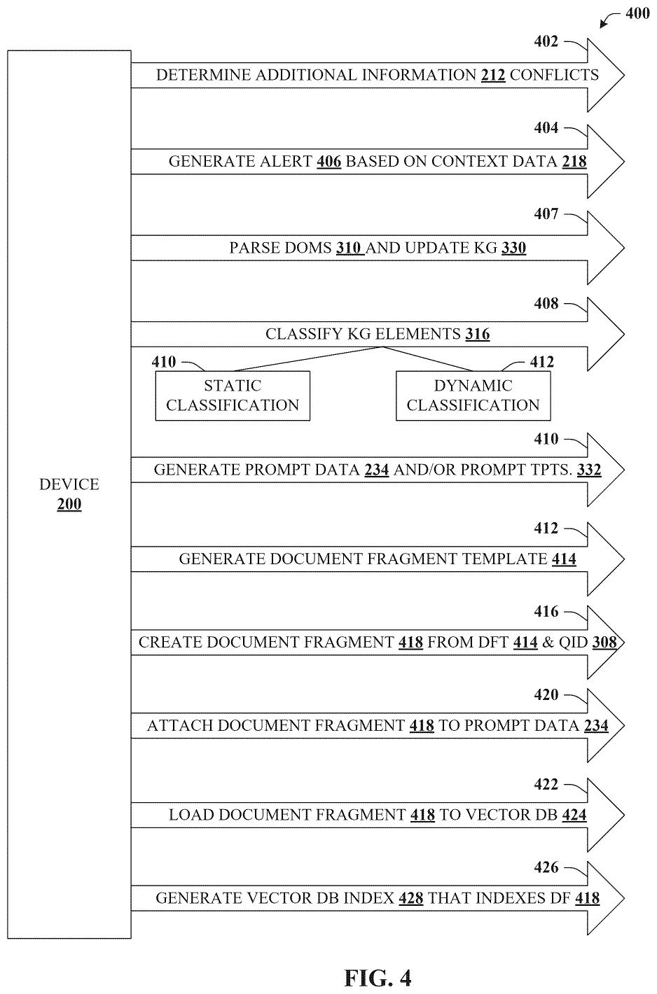

With reference now to FIG. 4, a schematic block diagram 400 illustrating additional elements or aspect of the example device 200 that can dynamically generate prompts 234 and knowledge bases or knowledge graphs 330 based on context data 218, which can be utilized to generate additional information 212 in accordance with certain embodiments of this disclosure.

At reference numeral 402, can determine additional information 212 (e.g., information identified by LLM 238 in response to prompt data 234) that was solicited about dynamic element 214 conflicts with content 302 of dynamic element 214 that was presented on webpage 100. In the example in which content 302 of dynamic element 214 is a billing amount, such can indicate that the presented billing amount is not correct according to the analysis performed by LLM 238 that was based on prompt data 234.

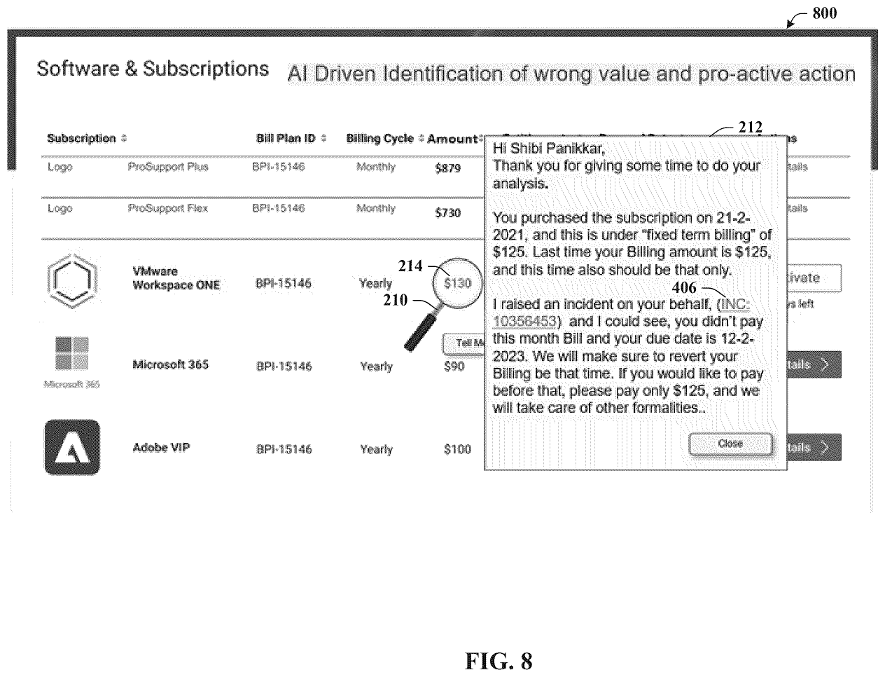

In response, at reference numeral 404, device 200 can generate an alert 406 based on context data 218. For instance, suppose additional information 212 indicates that the billing amount presented by webpage 100 is not correct. Device 200 can file an incident report on behalf of the user entity, an example of which is illustrated with reference to FIG. 8.

At reference numeral 407, device 200 can analyze or parse DOMS 310 of webpage 100. During the parsing, each WP element 312 can be identified and potentially assigned an identifier. In response to the parsing, an associated knowledge graph 330 that is specific to both webpage 100 (e.g., based on page identifier 226) and the user entity that accessed webpage 100 (e.g., based on user identifier 224) can be updated. Said updating can be to incorporate hierarchical representation 230 into the associated knowledge graph 330. As explained previously, hierarchical representation 230 can comprise KG elements 316 that are mapped from respective WP elements 312, and that maintains a same DOMS hierarchy 314 as DOMS 310 of webpage 100.

At reference numeral 408, device 200 can classify KG elements 316, for example according to a classification procedure. The classification procedure can classify a given KG element according to static classification 410 or according to dynamic classification 412. Static classification 410 can apply to KG elements 316 that are not configured to vary, such as for associated static elements 102 described in connection with FIG. 1. Dynamic classification 412 can apply to KG elements 316 that are configured to vary and to be determined concurrently with a presentation of webpage 100 such as content 302 of dynamic element 214 and/or dynamic elements 104 of FIG. 1.

While FIGS. 2 and 3C detailed the use of prompt data 234 and/or associated prompt templates 332, at reference numeral 410, it is further underscored that device 200 can construct or generate said prompt data 234 and prompt templates 332. As indicated prompt data 234 can represent a dynamically generated input to LLM 238 and prompt template 332 can represent a template used to generate prompt data 234 based on context data 218.

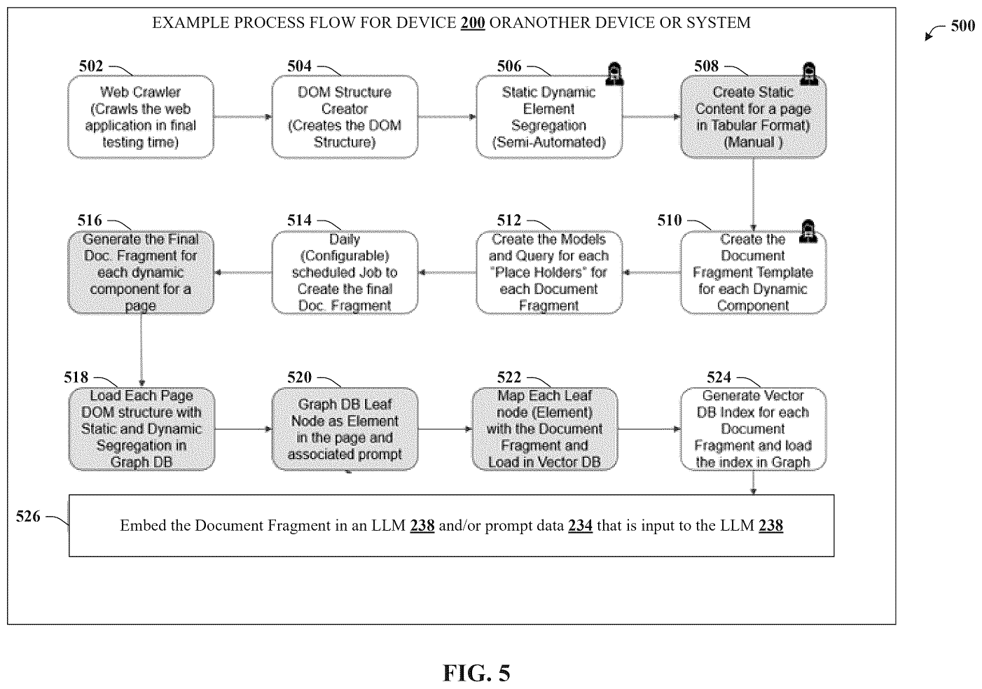

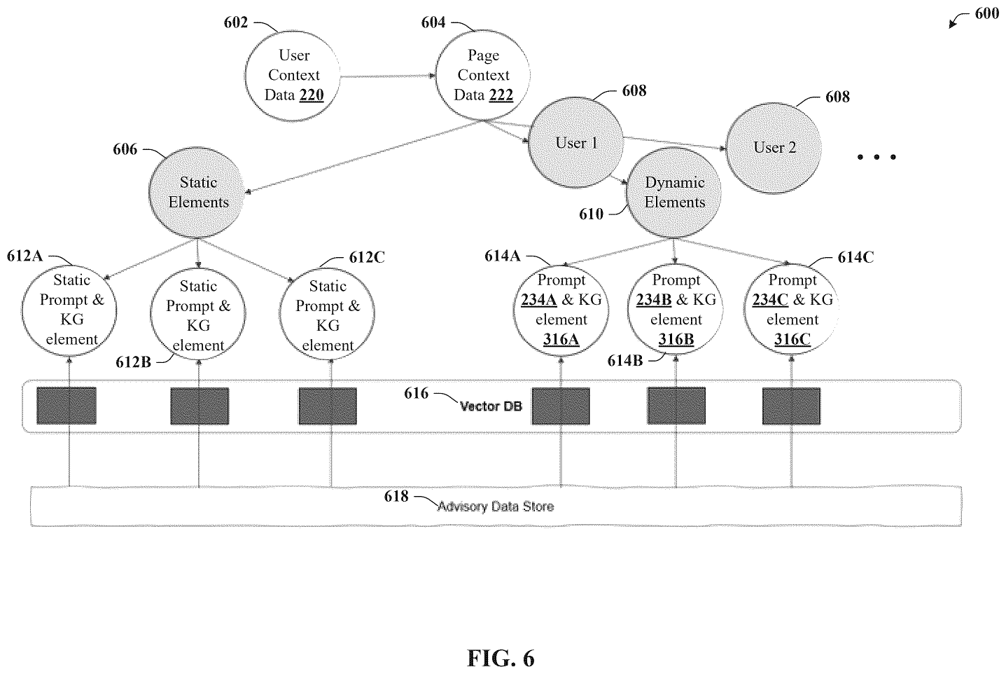

At reference numeral 412, device 200 can generate a document fragment template 414. Document fragment template 414 can be specific to a given KG element 316 of a given of a given hierarchical representation 230 of a given knowledge graph 330. Document fragment template 414 can comprise all (or a portion of) known queries about the associated KG element 316 as well as all (or a portion of) other known information about the associated KG element 316. Appreciably, said known queries and information can be expanded and/or updated over time and is further detailed in connection with FIGS. 5 and 6 below.

At reference numeral 416, device 200 can create document fragment 418 from document fragment template 414 and a reference (e.g., query ID 308) to a query (e.g., query 306) that obtains variable content (e.g., content 302) of dynamic element 214. At reference numeral 420, document fragment 418 can be attached to an associated instance of prompt data 234, for example, the instance of prompt data 234 that is associated with the same KG element 316 as is document fragment 418. In order to provide a concrete example, consider the example document fragment template 414 below:
Current Billing Amount is {Curr.Billing. QueryID}. Last three months billing amounts are {Q1}, {Q2} and {Q3}. The Difference between Current Billing Amount and an Average of the Last three Billing Amounts is {Curr.Billing. QueryID}−({Q1}+{Q2}+{Q3})/3. If the Different is more that 2% then raise a red flag. Itemized Billing Amount and customer usage are {Q4}. Next month Billing Amount is expected as {Model1.Predict1}

As noted document fragment template 414 can represent a format by which an associated document fragment 418 is created. The dynamic content can be given as a placeholder such as {queryID}, which can be indicative of query ID 308. Dynamic content can be determined according to two different procedures, namely data store based, which can represent current or historical values that can be retrieved from a data store (e.g., data store 304), or predictive, which can represent a future prediction. The predictive procedure can use any suitable model (e.g., labeled as {Model1.Predict1} such as a linear regression model, a random forest model, or another model depending on the use case. In this scenario, for example, Model1.Predict1 can be a predictive model based on a linear regression model using the last 6-12 months of billing data.

It is appreciated that in some embodiments, document fragment template 414 can comprise substantially all known details that can be provided as additional information 212 and substantially all questions about a given KG element 316 that a user entity might be inclined to ask. Document fragment template 414 can subsequently be converted to embeddings for LLM 238 and/or be used to create an associated document fragment 418.

At reference numeral 422, device 200 can load document fragment 418 to a vector database 424 associated with LLM 238. At reference numeral 426, device 200 can generate vector database index 428. Vector database index 428 can index a group of document fragments 418 including the particular document fragment loaded into vector database 424 as part of reference numeral 422. Additional detail regarding procedures indicated at reference numerals 422 and 426, as well as others reference numerals associated with FIG. 4 can be found in connection with FIGS. 5 and 6.

Turning now to FIG. 5, a schematic process flow diagram 500 is depicted illustrating example procedures or function of device 200 or another device or system operatively coupled to device 200 in accordance with certain embodiments of this disclosure.

Before reviewing elements of FIG. 5, it can be instructive to review certain high level functionality of device 200 with respect to the disclosed techniques. For example, in some embodiments, when a user entity logs into a particular web application, device 200 can determine all or a portion of user context data 220. When the user entity navigates to a given webpage (e.g., webpage 100), device 200 can create all or a portion of page context data 222 for that particular user entity (e.g., user ID 224), and said context data 218 can be stored in a backend store.

When the user entity provides indication 210, device 200 can derive the selected element (e.g., dynamic element 214) and value in the given context. Device 200 can then determine a business context from a page context mapper (discussed infra with regard to FIG. 5) against the page/element/value combination. Device 200 can then use these contexts to generate an advisory (discussed infra with regard to FIG. 5).

In that regard, device 200 can begin with knowledge and standard template base for an associated workflow. Device 200 can generate a prompt (e.g., prompt data 234) based on the particular element or value selected by the user entity. Device 200 can then automatically modify the knowledge base (e.g., knowledge graph 330) and templates based on model training or feedback from the user entity or another source.

Thereafter, device 200 can input the prompt to LLM 238 or any suitable generative AI-type device, which can produce a response from an automatically generated template and associated prompt. Such can also be fed to a reinforcement model that can learn based on negative feedback, as well as a classification model that can classify similar actionable elements in order to generate the advisory.

Device 200 can further display cached page context and customer context initially while the advisory is being generated. Device 200 can display the generative AI (e.g., LLM 238) response (e.g., additional information 212) for the selected element or value.

The aforementioned advisory can be an AI-based advisory creator, which can, in some embodiments, be segregated into different modules, including an element value advisory document creator that can be directed to background processes, an element value-based prompt generator, and an advisory generator that can provide generative AI responses based on element value and prompts. Additional detail regarding these modules can be found in connection with FIG. 5.

Regarding FIG. 5, it is appreciated that elements detailed therein can relate to background processes that can be performed as part of the element value advisory document creator, many of which were introduced in FIG. 4. At reference numeral 502, a web crawler or other suitable element can be instructed to crawl through the UI elements of a webpage and capture all the elements and associated values found in a DOM structure (e.g., DOMS 310) with associated element IDs. For example, a billing amount label can have an element ID of ‘lblBilling’, while a billing amount value can have an element ID of ‘valBilling’. It is noted that lblBilling is a static element 102 whereas valBilling is dynamic element 104.

At reference numeral 504, a DOM structure creator can create hierarchical representation 230, which can be mapped from DOMS 310 and maintain a same hierarchy 314 as DOMS 310. For example, a component hierarchy creator can create hierarchical representation 230 for a given webpage 100 based on the DOM structure and such can be stored in knowledge graph 330.

At reference numeral 506, element (e.g., KG elements 316) can be segregated by either a static classification 410 or a dynamic classification 412. In other words, the various KG elements 316, that are mapped from associated WP elements 312 can be separated according to the appropriate classification, either static classification 410 or dynamic classification 412.

At reference numeral 508, static content for webpage 100 can be created, for example in a tabular format. As an example, given the billing label is a static element, additional static content could be information like “this field will show your current billing amount” or something similar. Such can result from user content creator that determines all relevant information about a user entity upon login to the web application, and a page component document creator that generates a (e.g., single) static document page fragment against all static element 102 of webpage 100 and an associated prompt can provide the details for respective static elements 102.

At reference numeral 510, a document fragment template 414 can be created for each dynamic element 214. In that case, it is understood that the billing amount is dynamic and varies for each user and by time. Thus, a prompt mapper can be employed to capture and match the prompt for each dynamic element 214. Moreover, the page component document creator can generate a dynamic document page fragment (e.g., document fragment 418) for each dynamic element 214. Document fragment 418 can comprise a knowledge base utilized for all possible customer queries about the given dynamic element 214. The knowledge base can be pre-defined initially and add more content as user feedback is obtained

At reference numeral 512, various models and queries can be created for each placeholder for each document fragment 418. Such can have two parts. For example, a first part can be to query for dynamic content (e.g., content 302). Such can represent a database query (e.g., query 306) for obtaining the dynamic variability in the document, and which can be mapped to query ID 308. A second part can be to use AI models in connection with predictive analysis (e.g., find the predicted billing amount for next month).

At reference numeral 514, creation of the finalized document fragment 418 can be scheduled. At reference numeral 516, the finalized document fragment 418 can be generated for each dynamic element 214 of a given webpage 100. For example, a content generator can use the query ID 308 and document fragment template 414 to generate document fragment 418 with a mapping of dynamic element 214.

At reference numeral 518, a DOMS 310 can be loaded for each webpage 100 into knowledge graph 330. WP elements 312 and/or associated KG elements 316 can be separated into static or dynamic groups. At reference numeral 520, each dynamic element 214 can be represented as a leaf node for knowledge graph 330.

At reference numeral 522, each leaf node can be mapped with an associated document fragment and loaded into a vector database. At reference numeral 524, a vector database index can be generated for each document fragment. The vector database index can be loaded into knowledge graph 330.

At reference numeral 526, a given document fragment 418 can be embedded in an LLM 238 and/or prompt data 234 that is input to the LLM 238. Hence, the document fragment can be stored to knowledge graph 330, as can a starting prompt for a given dynamic element 214. For example, if dynamic element 214 is ‘valBilling’, a starting prompt can be stored that indicates, e.g., “show me a summary of billing details in bullet points”.

With reference now to FIG. 6, a schematic block diagram 600 is depicted illustrating a more detailed hierarchical view of the knowledge graph 330 in accordance with certain embodiments of this disclosure. For example, a different knowledge graph 330 can be constructed for each different user entity and for each different webpage 100. As illustrated at user context node 602 and page context node 604, such is accomplished via context data 218, namely in the present example, the knowledge graph 330 can be keyed to specific user context data 220 (e.g., user ID 224) and specific page context data 222 (e.g., page ID 226) that identifies a specific webpage 100.

Static elements node 606 (e.g., static elements 102) and dynamic elements node 610 (e.g., dynamic elements 104 and 214) are segregated (e.g., via a classification procedure 408) and occupy different branches of the hierarchy of knowledge graph 330. For example, static elements node 606 can be stored directly under page context node 604, as associated static element 102 are static and do not change on a user-by-user basis. Each different static element node 612A, 612B, 612C, and so on can be comprise a static prompt, an associated KG element that maps to a specific static element 102 of webpage 100, and a document vector database index that identifies the static element within vector database 616. Vector database 616 can be substantially similar to vector database 424 of FIG. 4.

The hierarchy for dynamic elements can be stored under page ID 226 (e.g., page context node 604) and user node 608 such that the values and hierarchy for dynamic elements node 610 can vary per user. Each different dynamic element node 614A, 614B, 614C, and so on can be comprise a different dynamic prompt (e.g., prompts 234A, 234B, 234C, respectively), an associated KG element (e.g., KG elements 316A, 316B, 316C, respectively) that maps to a specific dynamic element 104 (e.g., dynamic element 214) of webpage 100. Each different dynamic element node 614 can further comprise a document vector database index (e.g., document vector data index 428) that identifies the dynamic element within vector database 616. Additional information 212 can be retrieved from advisory data store 618.

Hence, in operation, when a given user entity invokes indication 210 in any suitable manner such as by dragging and dropping analysis element 106 on some element 102, 104 of webpage 100, device 200 can identify the selected element 102, 104 from DOMS 310. Thereafter, a call can be made to knowledge graph 330 to get the associated vector database index (e.g., vector database index 428) and the associated prompt (e.g., prompt data 234) against the selected element by passing context data 218 such as user ID 224 and page ID 226.

From knowledge graph 330, the vector database document fragment index and the initial prompt can be retrieved. The vector database index can be loaded so that LLM 238 can be apprised that only the associated document fragment (e.g., document fragment 418) need be searched. Device 200 can then pass the prompt to LLM 238 in order to receive the associated additional information 212. In some embodiments, additional information 212 can comprise an invitation to input data directly to LLM 238, which is further detailed in connection with FIG. 7. In some embodiments, additional information 212 can comprise an indication of alert 406, which is further detailed in connection with FIG. 8.

Turning now to FIG. 7, a graphical depiction of a webpage 700 is depicted illustrating a first example of the additional information 212 being presented in accordance with certain embodiments of this disclosure. In this example, it is assumed that indication 210 has been received by a user entity selecting dynamic element 214, which in this case is the indicated billing amount of $879. In response, additional information 212 can be presented.

In this example, an AI-driven analysis is implemented as detailed herein that can explain the reason for the different billing amount. For instance, additional information 212 explains that although the normal monthly amount is $729, which is what was billed in the previous month, the current month is higher due to the 15 hour overage of support. Also illustrated is an invitation 702 to ask specific further questions, which can be provided to LLM 238 directly, noting that prompt data 234 was not created or input by the user entity, but was dynamically generated by device 200.

Referring now to FIG. 8, a graphical depiction of a webpage 800 is depicted illustrating a second example of the additional information 212 being presented in accordance with certain embodiments of this disclosure. In this example, it is assumed that indication 210 has been received by a user entity selecting dynamic element 214, which in this case is the indicated billing amount of $130. In response, additional information 212 can be presented.

In this example, an AI-driven analysis is implemented as detailed herein to identify an incorrect value and to proactively resolve an associated issue. For instance, additional information 212 explains that the selected billing amount appears to be in error and should be the same as last month, only $125. Additional information further indicates that alert 406 has been raised, namely that an incident report has been created to look into the discrepancy and rectify the situation on behalf of the user entity.

### Example Methods

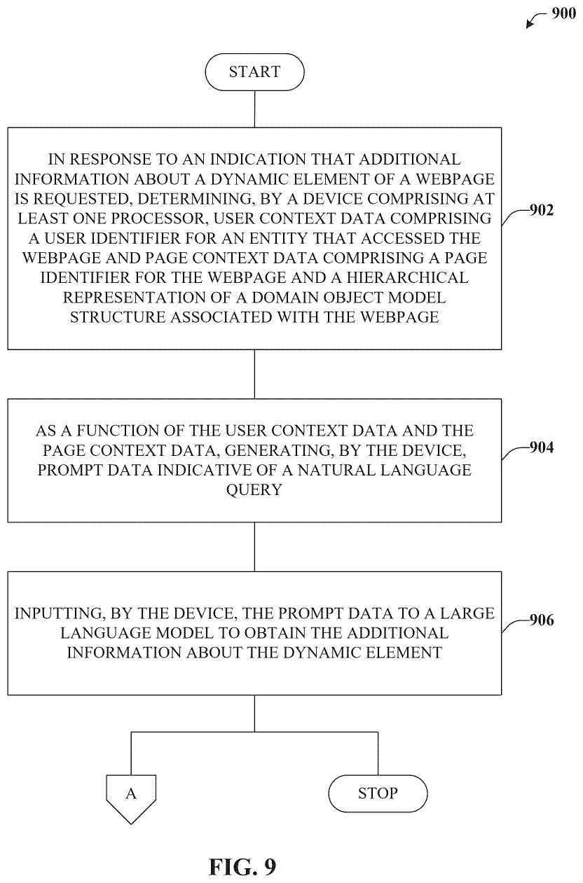

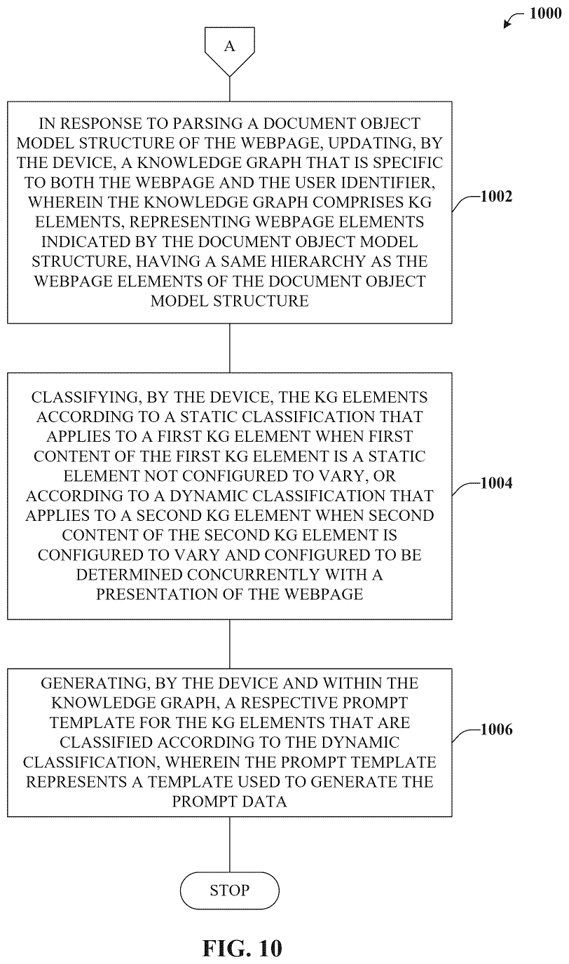

FIGS. 9 and 10 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 9, exemplary method 900 is depicted. Method 900 can dynamically generate prompts and knowledge bases or knowledge graphs based on context data, which can be utilized to generate additional information in accordance with certain embodiments of this disclosure. While method 900 describes a complete method, in some embodiments, method 900 can include one or more elements of method 1000, reached via insert A, as discussed at FIG. 10.

At reference numeral 902, a device comprising at least one processor can receive an indication that information about a dynamic element of a webpage is requested. The information can be additional information that is not currently apparent from the presentation of the webpage. In response to the indication, the device can determine user context data and page context data. The user context data can comprise a user identifier for an entity that accessed the webpage. The page context data can comprise a page identifier for the webpage and a hierarchical representation of a domain object model structure associated with the webpage.

At reference numeral 904, as a function of the user context data and the page context data, generating, by the device, prompt data. The prompt data can be indicative of a natural language query.

At reference numeral 906, the device can input the prompt data to a large language model, a generative AI model, or another suitable model in order to obtain the information about the dynamic element. Method 900 can terminate in some embodiments, or proceed to insert A in other embodiments, which is further detailed in connection with FIG. 10.

Turning now to FIG. 10, exemplary method 1000 is depicted. Method 1000 can provide for additional elements or functionality relating to dynamically generating prompts and knowledge bases or knowledge graphs based on context data in accordance with certain embodiments of this disclosure.

For example, at reference numeral 1002, in response to parsing a document object model structure of the webpage, updating, by the device, a knowledge graph. The knowledge graph can be specific to both the webpage and the user identifier. The knowledge graph can comprise knowledge graph elements representing webpage elements indicated by the document object model structure. The knowledge graph can have a same hierarchy as the webpage elements of the document object model structure.

A reference numeral 1004, the device can classify the knowledge graph elements according to a static classification or a dynamic classification. The static classification can apply to a first knowledge graph element when first content of the first knowledge graph element is a static element that is not configured to vary. The dynamic classification can apply to a second knowledge graph element when second content of the second knowledge graph element is configured to vary and configured to be determined concurrently with a presentation of the webpage, such as via a query to a data store.

A reference numeral 1006, the device can generate a respective prompt template for the knowledge graph elements that are classified according to the dynamic classification. The prompt template can represent a template used to generate the prompt data.

### Example Operating Environments

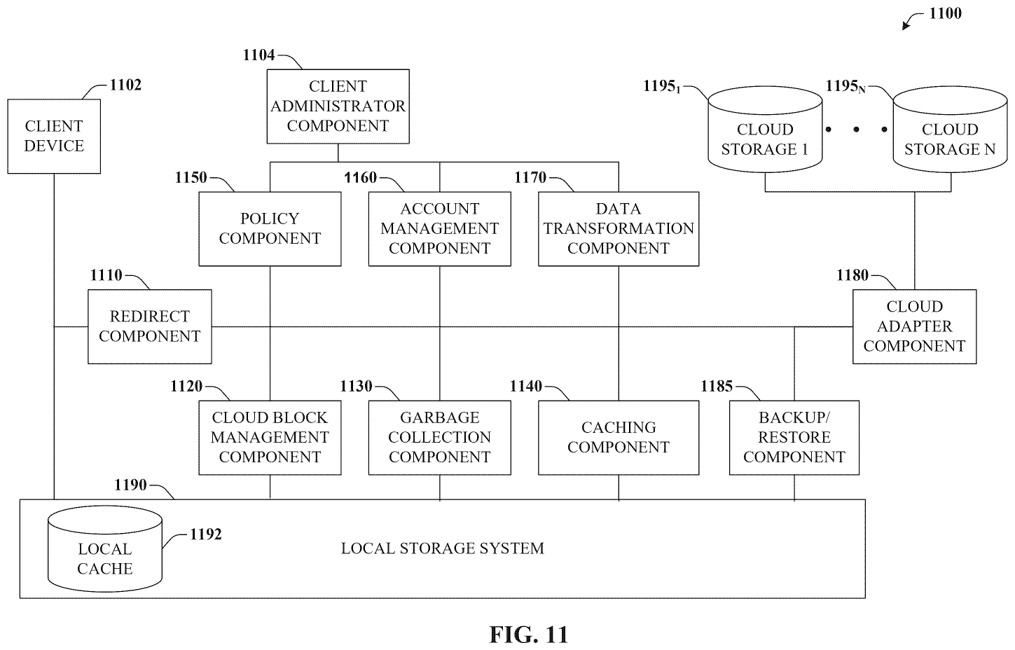

To provide further context for various example embodiments of the subject specification, FIGS. 11 and 12 illustrate, respectively, a block diagram of an example distributed file storage system 1100 that employs tiered cloud storage and block diagram of a computer 1202 operable to execute the disclosed storage architecture in accordance with example embodiments described herein.

Referring now to FIG. 11, there is illustrated an example local storage system including cloud tiering components and a cloud storage location in accordance with implementations of this disclosure. Client device 1102 can access local storage system 1190. Local storage system 1190 can be a node and cluster storage system such as an EMC Isilon Cluster that operates under OneFS operating system. Local storage system 1190 can also store the local cache 1192 for access by other components. It can be appreciated that the systems and methods described herein can run in tandem with other local storage systems as well.

As more fully described below with respect to redirect component 1110, redirect component 1110 can intercept operations directed to stub files. Cloud block management component 1120, garbage collection component 1130, and caching component 1140 may also be in communication with local storage system 1190 directly as depicted in FIG. 11 or through redirect component 1110. A client administrator component 1104 may use an interface to access the policy component 1150 and the account management component 1160 for operations as more fully described below with respect to these components. Data transformation component 1170 can operate to provide encryption and compression to files tiered to cloud storage. Cloud adapter component 1180 can be in communication with cloud storage 1 1195₁ and cloud storage N 1195_{N}, where N is a positive integer. It can be appreciated that multiple cloud storage locations can be used for storage including multiple accounts within a single cloud storage location as more fully described in implementations of this disclosure. Further, a backup/restore component 1185 can be utilized to back up the files stored within the local storage system 1190.

Cloud block management component 1120 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1120 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1160 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1120 based on a list of mappings that the cloud block management component 1120 manages. For example, each stub can be associated with an account, and the cloud block management component 1120 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1180 manages the sending and receiving of data to and from the cloud service providers. The cloud adapter component 1180 can utilize a set of APIs. For example, each cloud service provider may have provider specific API to interact with the provider.

A policy component 1150 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1130. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1130 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1140 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1120, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1140 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1140 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1170 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 1185 can transfer a copy of the files within the local storage system 1190 to another cluster (e.g., target cluster). Further, the backup/restore component 1185 can manage synchronization between the local storage system 1190 and the other cluster, such that, the other cluster is timely updated with new and/or modified content within the local storage system 1190.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various example embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations, comprising:
in response to an indication that information about a dynamic element of a webpage is solicited, determining context data comprising:
user context data comprising a user identifier for an entity that accessed the webpage; and
page context data comprising a page identifier for the webpage and a hierarchical representation of a domain object model structure associated with the webpage;
as a function of the user context data and the page context data, generating prompt data indicative of a natural language query; and
inputting the prompt data to a large language model to obtain the information about the dynamic element.

2. The device of claim 1, wherein the dynamic element comprises content that is configured to vary according to a determination that occurs when the webpage is presented.

3. The device of claim 1, wherein the prompt data comprises a reference to a query that obtains variable content of the dynamic element.

4. The device of claim 1, wherein the hierarchical representation comprises knowledge graph elements that map to webpage elements referenced in a document object model structure of the webpage.

5. The device of claim 1, wherein the prompt data is generated by applying the context data to a prompt template stored in a knowledge graph associated with the webpage, and wherein the prompt template is specific to a particular knowledge graph element of the hierarchical representation.

6. The device of claim 5, wherein the operations further comprise, in response to a determination that the information that was solicited about the dynamic element conflicts with content of the dynamic element, generating an alert based on the context data.

7. The device of claim 1, wherein the operations further comprise:
in response to parsing a document object model structure of the webpage, updating a knowledge graph that is specific to both the webpage and the user identifier, wherein the knowledge graph comprises knowledge graph elements, representing webpage elements indicated by the document object model structure, having a same hierarchy as the webpage elements of the document object model structure;
classifying the knowledge graph elements according to a static classification that applies to a first knowledge graph element when first content of the first knowledge graph element is a static element that is not configured to vary, or according to a dynamic classification that applies to a second knowledge graph element when second content of the second knowledge graph element is configured to vary and configured to be determined concurrently with a presentation of the webpage; and
generating within the knowledge graph a respective prompt template for the knowledge graph elements that are classified according to the dynamic classification, wherein the prompt template represents a template used to generate the prompt data.

8. The device of claim 1, wherein the operations further comprise generating a document fragment template that is specific to a given knowledge graph element of the hierarchical representation, and wherein the document fragment template comprises known queries about the knowledge graph element and known information about the knowledge graph element.

9. The device of claim 8, wherein the operations further comprise generating a document fragment from the document fragment template and a reference to a query that obtains variable content of the dynamic element and attaching the document fragment to the prompt data.

10. The device of claim 9, wherein the operations further comprise loading the document fragment to a vector database associated with the large language model.

11. The device of claim 10, wherein the operations further comprise generating a vector database index that indexes a group of document fragments comprising the document fragment.

12. A method, comprising:
in response to an indication that information about a dynamic element of a webpage is requested, determining, by a device comprising at least one processor, user context data comprising a user identifier for an entity that accessed the webpage and page context data comprising a page identifier for the webpage and a hierarchical representation of a domain object model structure associated with the webpage;
as a function of the user context data and the page context data, generating, by the device, prompt data indicative of a natural language query; and
inputting, by the device, the prompt data to a large language model to obtain the information about the dynamic element.

13. The method of claim 12, further comprising, in response to parsing a document object model structure of the webpage, updating, by the device, a knowledge graph that is specific to both the webpage and the user identifier, wherein the knowledge graph comprises knowledge graph elements, representing webpage elements indicated by the document object model structure, having a same hierarchy as the webpage elements of the document object model structure.

14. The method of claim 13, further comprising, classifying, by the device, the knowledge graph elements according to a static classification that applies to a first knowledge graph element when first content of the first knowledge graph element is a static element that is not configured to vary, or according to a dynamic classification that applies to a second knowledge graph element when second content of the second knowledge graph element is configured to vary and configured to be determined concurrently with a presentation of the webpage.

15. The method of claim 14, further comprising, generating, by the device and within the knowledge graph, a respective prompt template for the knowledge graph elements that are classified according to the dynamic classification, wherein the prompt template represents a template used to generate the prompt data.

16. A non-transitory computer-readable medium comprising instructions that, in response to execution, cause a system comprising a processor to perform operations, comprising:
in response to an indication that information about a dynamic element of a webpage is solicited, determining:
user context data comprising a user identifier for an entity that accessed the webpage; and
page context data comprising a page identifier for the webpage and a hierarchical representation of a domain object model structure associated with the webpage;
as a function of the user context data and the page context data, generating prompt data indicative of a natural language query; and
inputting the prompt data to a large language model to obtain the information about the dynamic element.

17. The non-transitory computer-readable medium of claim 16, wherein the hierarchical representation comprises knowledge graph elements that map to webpage elements referenced in a document object model structure of the webpage.

18. The non-transitory computer-readable medium of claim 16, wherein the operations further comprise generating a document fragment template that is specific to a given knowledge graph element of the hierarchical representation, wherein the document fragment template comprises known queries about the knowledge graph element and known information about the knowledge graph element.

19. The non-transitory computer-readable medium of claim 18, wherein the operations further comprise generating a document fragment from the document fragment template and a reference to a query that obtains variable content of the dynamic element.

20. The non-transitory computer-readable medium of claim 19, wherein the operations further comprise loading the document fragment to a vector database associated with the large language model and generating a vector database index that indexes a group of document fragments comprising the document fragment.
